(19) United States
(12) Patent Application Publication
(10) Pub. No.: US 2003/0025791 A1
(43) Pub. Date: Feb. 6, 2003

(54) Trailer mounted surveillance system

(75) Inventors: Kenneth Kaylor, Woodinville, WA (US); Brian Kaylor, Vacaville, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Kenneth Kaylor, Woodinville, WI (US)

(21) Appl. No.: 10/188,301

(22) Filed: Jul. 1, 2002

Related U.S. Application Data
(60) Provisional application No. 60/301,863, filed on Jun. 29, 2001.

(51) Int. Cl. H04N 7/16; H04H 9/00; H04N 7/18; H04N 9/47

(52) U.S. Cl. 348/143; 348/139; 348/159; 725/12

(57) ABSTRACT

A video surveillance system is provided, including a wheeled trailer, a lockable cabinet mounted on the trailer and a mast, coupled to the trailer and capable of being folded for storage and transport and capable of being extended vertically. A plurality of video cameras are mounted on the mast, a screen splitter is located within the cabinet and receives video images at each of the plurality of cameras and combines the plurality of images into a single video image at an output. A video recorder located within the cabinet and having an input coupled to the output of the screen splitting device records the combined image from the screen splitter.

### CROSS-REFERENCE TO RELATED APPLICATION

This application claims the benefit of U.S. Provisional Patent Application No. 60/301,863 filed Jun. 29, 2001, where this provisional application is incorporated herein by reference in its entirety.

### BACKGROUND OF THE INVENTION

1. Field of the Invention

The present invention relates to the field of video surveillance, and in particular to equipment for use in applications where the need for video surveillance is temporary.

2. Description of the Related Art

With changes in society, both locally and globally, comes the need for more effective surveillance and security measures. Increasing threats to life and property demand more comprehensive and coordinated efforts to curtail those threats. Tight budgets, meanwhile, demand more creative use of available funds and careful selection of resources to be applied to many different situations as needs evolve.

While there are many locations and situations that benefit from permanent surveillance arrangements, other situations require only temporary measures. In a given municipality, for example, there may, at various times, be requirements to examine traffic patterns and compliance with traffic laws in order to allocate resources and enforcement efforts. In the same municipality, a two day arts festival may require increased patrol and surveillance for a short period, then at another time efforts may be required to reduce crime in a particular area of the city. A large sports event or concert may bring crowds to a stadium. A political rally or protest will bring a different crowd to a different part of the city. The ability to shift personnel and materiel smoothly and quickly from one area to another could make the difference between a quiet season and one fraught with crime, violence or controversy. It may also make the difference between controlled expenses and a budget busting series of emergency overtime crises.

Similar problems are faced by private companies. For example, construction sites are very tempting to thieves and vandals, but when a project is completed the temptation diminishes greatly. A general contractor may have several sites in various stages of completion, with varying needs for security. Staging areas for movement of freight and supplies, such as train yards and shipping docks, may at times be loaded with valuable equipment, while at other times they could be deserted.

On a larger scale, border regions are constantly fluctuating in terms of the numbers of individuals who attempt to cross from one side to another at various points along the border.

A fundamental need in all these examples is effective surveillance. However, the various possible choices can be labor intensive or expensive. For instance, to control a large crowd, a certain number of individuals will be required to watch for situations that may require moderating efforts. Those efforts must be applied by a different group of individuals, so that the observers can remain at their posts. The more observers there are, the shorter the response time will be to any need, thus, the fewer will be needed in the second group of people. Nevertheless, the total manpower required can be large.

In locations vulnerable to theft, it's not uncommon for thieves to work as teams, with one group tasked with drawing surveillance and response personnel away while another group goes after the target. An effective video surveillance system can significantly reduce the number of observers required, while still permitting quick response and maintaining continued observation. The trade off is in the cost of equipment. In the situations described above, the need for surveillance is temporary, but the cost of installing and activating an effective video surveillance system does not go down just because the need is only temporary, not to mention the requirement for sufficient advance notice to set up the equipment in the first place.

In order to control the rising costs of improvements to infrastructure, traffic studies may be undertaken to examine one or more of several components of traffic operation in a particular area. For example, an intersection might be monitored for traffic density, i.e., how many vehicles pass through the intersection at any given time, and in which directions? The intersection might be monitored for compliance, i.e., how many traffic infractions occur and at what times? A cross walk might be a safety concern for school children crossing a heavily traveled street, so a study might monitor vehicle speed and density as well as pedestrian crossing at that location at critical times. Railroad grade crossings are often a concern, and a study might examine traffic patterns and behavior of motorists with respect to a grade crossing.

Any one of these studies might need to be conducted repeatedly at different times and locations in order to accurately determine where improvements or increased patrols by police are justified or will be most effective.

As with the situations discussed above, generally the choice is between placing one or more human observers at the particular location, or placing electronic monitoring equipment. Again, the trade-offs are similar. Because of the temporary nature of the observation, it is easiest to use live observers. However, the expense of paying observers to watch traffic, especially for extended periods, can be significant. Second, an observer may miss one event while recording another. Accuracy of recording is also an issue. For example, will an observer be able to accurately determine whether a light changed just before or just after a car enters an intersection. As the amount of data required from a single observer increases, the accuracy of the data collected will decrease. The danger also exists that an observer will falsify data, either to achieve a desired result or out of an unwillingness to persevere in the study.

On the other hand, the use of electronic systems includes the expense of installation at each site, plus the cost of reviewing and correlating the data. The cost and complexity of organizing and setting up such systems may prevent the effective allocation of funds that are available for needed improvement.

### BRIEF SUMMARY OF THE INVENTION

According to an embodiment of the invention, a video surveillance system is provided, including a wheeled trailer, a lockable cabinet mounted on the trailer, a mast, coupled to the trailer and capable of being folded for storage and transport and capable of being extended vertically, a plurality of video cameras mounted on the mast, a screen splitter located within the cabinet and configured to receive a plurality of video images at each of a plurality of inputs and to combine the plurality of images into a single video image at an output, a video recorder located within the cabinet and having an input coupled to the output of the screen splitting device, and connection means for coupling outputs of each of the plurality of video cameras to a respective one of the plurality of inputs of the screen splitting device.

According to another embodiment of the invention, a remote video surveillance system is provided, including a wheeled trailer, a lockable cabinet mounted on the trailer, a mast, coupled to the trailer and capable of being folded for storage and transport and capable of being extended vertically, a plurality of video cameras mounted on the mast, transmission means for transmitting images from each of the plurality of video cameras to a remote location, and connection means for coupling outputs of each of the plurality of video cameras to the transmission means.

Another embodiment of the invention provides, in addition, a command vehicle to receive the transmissions from each of a plurality of remote video surveillance systems as described above.

An embodiment of the invention provides a video surveillance system, including a first video camera having a first focal length, a second video camera coupled to the first camera and having a second focal length longer than the first focal length, monitoring means for displaying video images from the first and second video cameras, wherein the video image from the first video camera includes a fiducial indicating the field of view of the second camera, and wherein the video image from the second camera corresponds to the portion of the video image from the first camera indicated by the fiducial.

An embodiment of the invention provides a device for antenna alignment, including an antenna, a video camera coupled to the antenna, monitoring means for viewing a video image from the video camera, wherein the video image includes a fiducial corresponding to a focal point of the antenna.

### BRIEF DESCRIPTION OF THE SEVERAL VIEWS OF THE DRAWINGS

For understanding the present invention, a description of a preferred embodiment thereof is now provided, purely as a non-limiting example, with reference to the attached drawings, wherein:

FIG. 1 shows a view of an embodiment of the invention in a deployed configuration;

FIG. 2 shows the embodiment of FIG. 1 in a secured configuration;

FIG. 3 shows a portion of the interior of the cabinet of the trailer of the embodiment shown in FIG. 1;

FIG. 4 illustrates the video image of a first video camera according to another embodiment of the invention;

FIG. 5 shows the video image of a second camera according to the embodiment illustrated in FIG. 4;

FIG. 6 illustrates the fields of view of a configuration of cameras according to an embodiment of the invention;

FIG. 7 shows a single frame image as recorded by the camera configuration of FIG. 6;

FIG. 8 shows the image of FIG. 7, framed by the fields of a software program for analyzing the data of the video images;

FIG. 9 is a diagrammatic representation of the electronic modules of the system;

FIG. 10 illustrates an additional embodiment of the invention; and

FIG. 11 is a diagrammatic representation showing a deployment of the embodiment of FIG. 10.

### DETAILED DESCRIPTION OF THE INVENTION

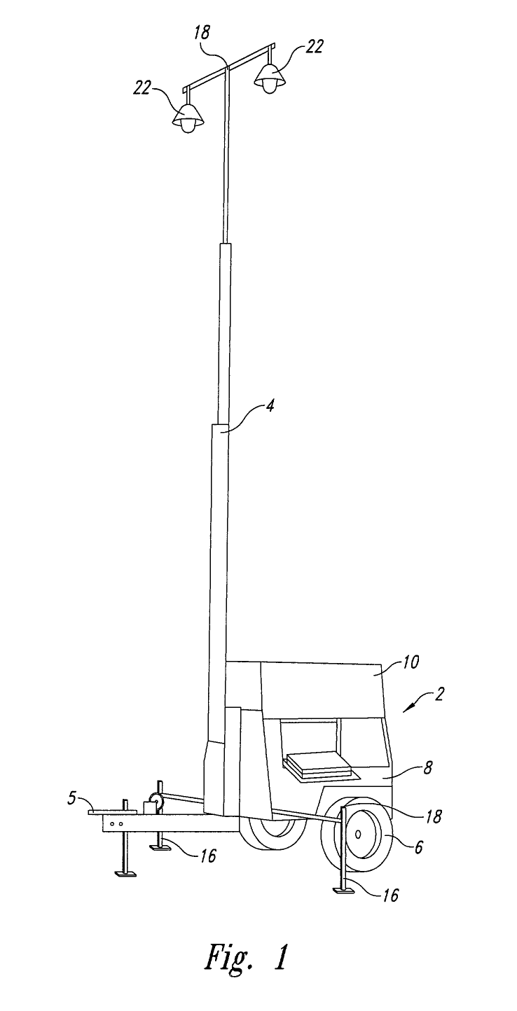

According to the principles of the invention, a trailer 2 is provided, having wheels 6 and a trailer hitch 5, and including a manual, hydraulic or motor driven erectable tower or mast 4, as shown in FIG. 1. The mast 4 may extend upward from twenty to seventy feet, or more. In a preferred embodiment, the mast 4 extends thirty feet. The trailer 2 is further provided with a cabinet 8 having lockable doors 10 for security of the contents. The cabinet portion 8 of the trailer 2 is constructed with appropriate seals and gaskets 12 to provide a weatherproof and dustproof enclosure for the contents of the cabinet 8. In another embodiment of the invention, only the portion of the cabinet 8 used to store electronic components is provided with seals or gaskets 12.

Batteries (not shown) may be accessible by means of a separate drawer in the cabinet, which may be pulled out for access to the batteries, or by other means, including shelves or sliding panels within the cabinet 8. The trailer 2 is further equipped with outriggers or braces 16 which may be deployed to provide stabilization on uneven terrain. Connection points 18 for guy wires, to be used to stabilize the mast 4 under high wind conditions, are provided on the mast 4 and on the trailer 2, outriggers 16 and trailer tongue 17. Anchors or stakes for the guy wires, to be driven into the ground for additional stability of the mast, may also be provided. Storage space for guy wires and anchors is provided in the cabinet 8. The trailer may also be provided with wheel locks, which are engaged to prevent the trailer from moving from its location. The wheel locks may be secured by lock and key to discourage theft, or access to the wheel locks may be from within the lockable cabinet 8. The outriggers 16, guy wires, and wheel locks are designed to by deployable by one individual. The size and shape of the trailer 8 is selected such that it may be easily transported with similar trailers in a side-by-side or end-to-end position in a standard cargo van or on a flatbed transportation trailer.

As shown in FIG. 1, a plurality of cameras 22 is attached to the upper end of the mast 4. The cameras 22 are provided with weatherproof and rustproof coverings to afford protection from the elements. The cameras 22 may be affixed to the mast 4 using a quick release mount, and may further employ safety lanyards to protect the cameras 22 in the event that the mount fails. Power, control and video cables 18 for the cameras 22 are fed through linkages in the mast 4 and through a weatherproof opening into the cabinet 8 of the trailer 2. The linkages are designed in such a fashion that, when the mast 4 is folded or stowed, the cable 18 folds along with the mast 4, without damage, and is held securely for transportation. When not in use, the cameras 22 are held in a storage space provided in the trailer 2 for that purpose. The storage space is equipped with padding and tie downs as required to prevent damage to the cameras 22.

Storage space may be provided in or on the trailer 2 for the storage of traffic cones, traffic signs and flags, and external work lights. The equipment in the cabinet 8 may also include a meter to measure the hours of operation of the system. The mast 4 may include inactive sockets 20 configured to mate with the cable connectors that, during operation of the system, are connected to the cameras 22. The inactive sockets 20 are positioned such, that the connectors at the ends of the control cables 18 may be attached to them when the tower 4 is folded up for storage or transit. The use of these sockets 20 secures the ends of the cables 18 and prevents damage caused by uncontrolled movement of the cable ends during transit.

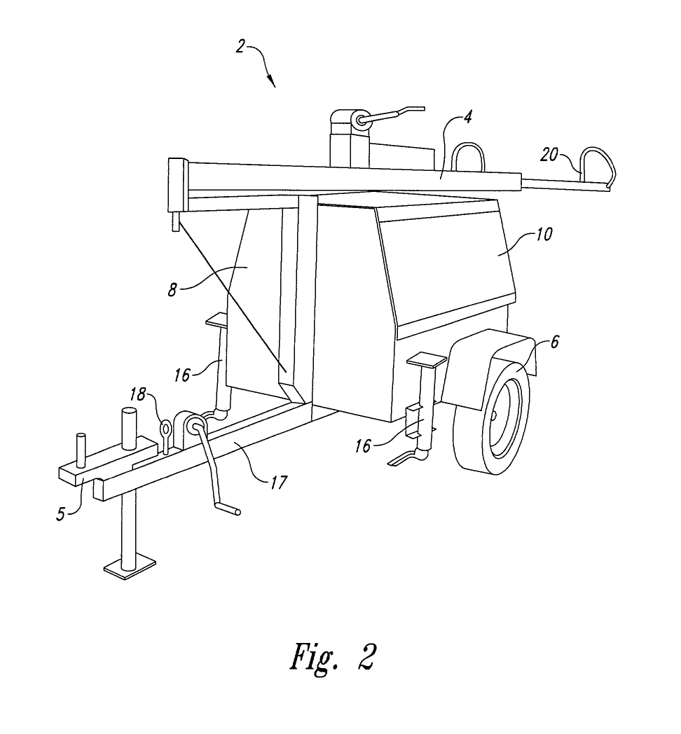

FIG. 2 shows the trailer 2, with the cabinet doors 10 closed, and the mast 4 folded and stowed for transport. The trailer 2 and hitch 5 have a standard configuration common to small trailers. The trailer 2 is readily maneuverable, and may be hitched or unhitched by a single individual with little effort. The trailer 2 is equipped with standard running lights, turn signals and reflectors.

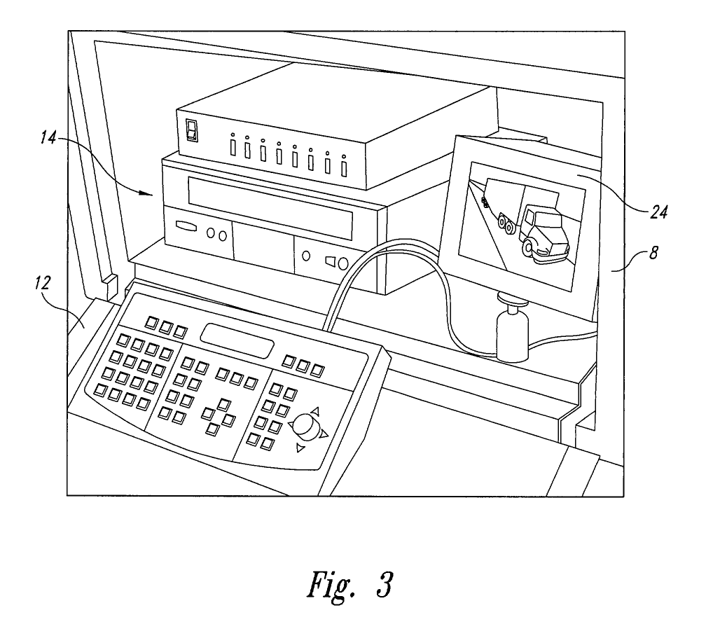

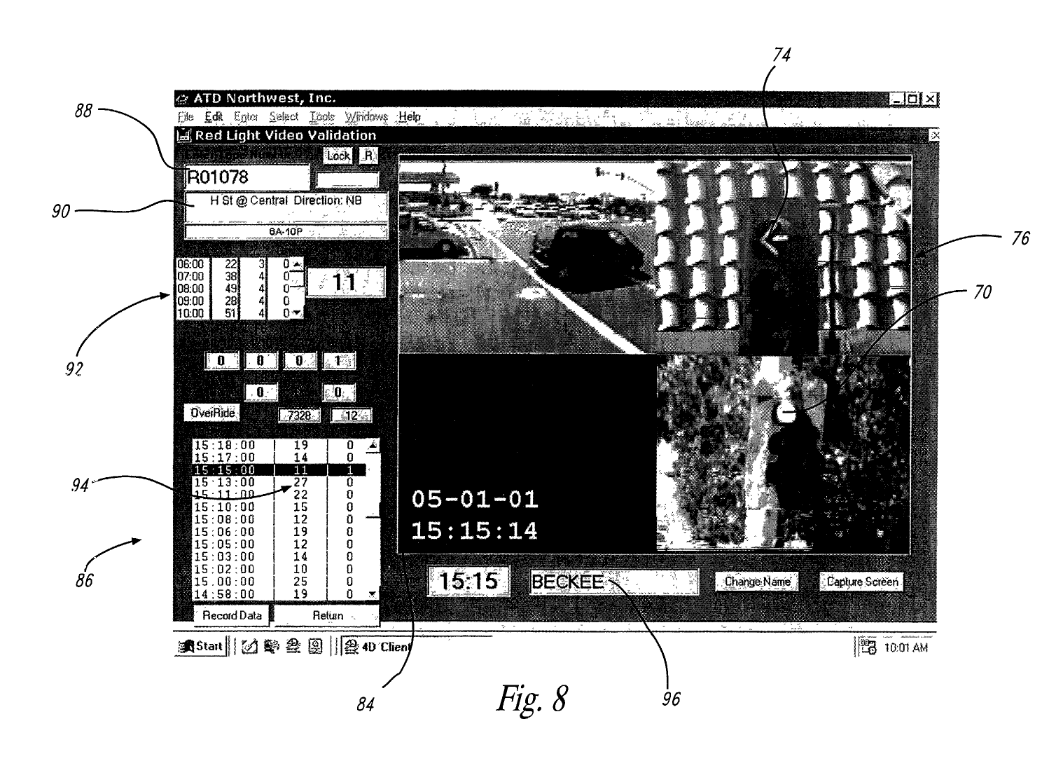

As shown in FIG. 3, the trailer is configured with appropriate electronic equipment 14 to support the specific requirements of the application. The equipment 14 is accessible via doors 10 and/or drawers in the cabinet 8 on the trailer 2. According to one embodiment of the invention, the contents 14 of the cabinet 8 will include a video recording device 34, for example, a video tape recorder, a solid state video recording device or a video disc recorder, with the capability of recording real time or time-lapse video for 24 hours or more. The cabinet 8 may also include a screen splitting device, capable of receiving a signal from two or more video cameras 22, and combining those video images onto a single video image, by splitting the frame of the image. Using such a device, the video image may be split vertically or horizontally into two, three, or four images, or more as required. This feature will be described in more detail below, with reference to FIG. 7. The screen splitter may be programmed to cycle the image from one camera to the next, or to show images of all the cameras 22 simultaneously, or to show images selected by an operator.

The cabinet 8 may also include a device that affixes a date and time stamp on a video image. A control device is included, in the event that the cameras 22 are of the pan/tilt/ zoom type, to control the cameras 22 affixed to the tower 4. A video monitor 24 is further included in the cabinet. An operator may, by viewing an image in the monitor, adjust the position, focus, and degree of zoom of a particular camera.

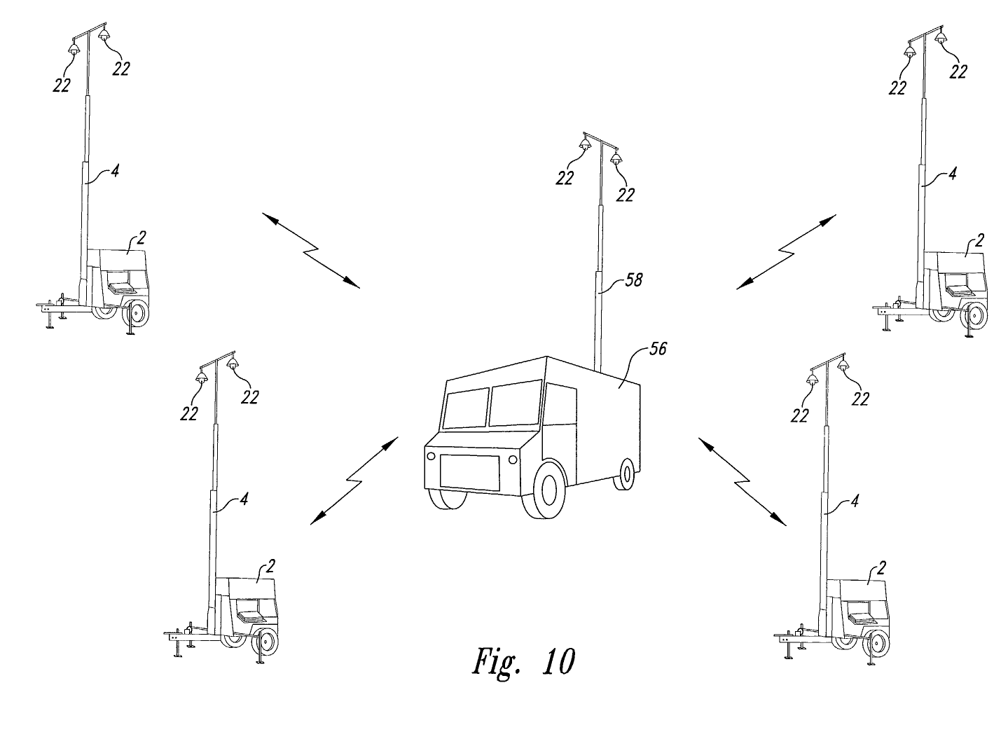

FIG. 9 shows a functional block diagram of the contents of the cabinet according to an embodiment of the invention. The functions represented may be performed by one, two or many discreet components, and the functions required may vary according to the application. Thus, many combinations of devices and functions according to the principles of the invention will be obvious to those skilled in the art, and need not be detailed here.

As shown in FIG. 9, a plurality of cameras 22 is attached to the mast 4. Video images from the cameras 22 are carried by the cables 18 to a distribution module 36. The distribution module 36 may provide power from the battery 38 to the cameras 22 via the same cables 18. In the event that the cameras 22 are equipped to pan, tilt or zoom, controls of these functions are made, through the cables 18 and via the distribution module 36, by the pan/tilt/zoom control module 40. The images from the individual cameras 22 is processed by the screen splitter 42 and combined into a single image. A date/time stamp 44 is placed on the image. The date/time stamp module 44 may also place a location code on the image if required. The combined image is recorded by the recording device 34. A monitor 24 is provided in the cabinet 8. The monitor may be used by the operator to set up and program the system for automatic or remote operation, and then be removed or turned off. Alternatively, an operator may manually control the system from the cabinet.

According to a preferred embodiment of the invention, the video recording device 34 is capable of recording up to 24 hours of continuous video images. This device may be programmed to record continuously, in a case, for example, where the system is configured to record traffic at an intersection, and all the traffic during a given period is to be recorded. In another application, it may be desired to record the traffic at peak hours, only, in which case, the recording device 34 is programmed to turn itself on and off appropriately, to capture video during those peak hours. In another application, it may be desired to record traffic during particular events, for example, at a train crossing during the approach and passage of a train as it passes a grade crossing. In such a case, the device 34 is programmed to receive a signal from a motion detector or other type of sensor that indicates the approach of a train, which signal would cause the device to turn on until a second signal is received indicating the complete passage of the train. Alternatively, the alarm signal of the crossing may be used to turn the system on and off. In another application, the high resolution available through continuous images may not be required. In such a case, the recording device 34 may be programmed to record time-lapse images, which allows continuous recording for a much longer period of time.

Standard video is recorded at a rate of thirty frames per second. A time lapse recording of, for example, four frames per second will allow data from 180 hours of real time to be recorded on a 24 hour video tape, for example, while still providing sufficient coverage for many application.

Any acceptable transmission structure and technique may be used with the system. Of the many techniques available, for example, images from the trailer 2 may be transmitted to a remote location via a telephone connection, a radio or a cellular phone antenna, a satellite link connection, hard wire cable, microwave, optical, or any other appropriate means for transmitting an image. The trailer cabinet 8 will include the appropriate transmitting equipment 46, according to the requirements of a particular application. It may be required that an operator have direct control of the cameras 22 or recorder 34 from a remote location. In this event the transmitter module 46 will also incorporate a receiver to receive a control signal from the operator. The cabinet 8 may include facilities for remote access from the Internet. An operator would then be able to monitor the cameras 22 in real time, or download the stored video. Remote access to metering equipment is also possible, allowing an operator to check battery levels or consumption of recording media, without the need to visit the site.

The cameras 22 affixed to the tower 4 may include a variety of types, depending upon the requirements of a particular application. For example, the cameras 22 may be color or black and white, they may also be infrared sensitive cameras. The cameras may include zoom lenses, wide-angle lenses, or telephoto lenses. They may include remotely controlled motors for pan and tilt. The cameras 22 may be configured to provide wide-angle surveillance of an area, or to provide stereo imaging of a subject of interest. The cameras may be slaved together to provide different types of images of the same view, or they may be operated independently of each other. The cameras 22 and recording system 34 may operate automatically according to preset instructions, or may be controlled by an operator at the trailer or at a remote location.

Batteries 38 are included in the trailer to provide power for the equipment 14 and for the cameras 22. According to one embodiment of the invention, deep cycle marine batteries are used to provide this power. According to a preferred embodiment, four deep cycle marine batteries are provided in the trailer 2. An AC/DC converter 48 is provided with provisions to run the system off of external AC power on a continuous basis or to charge the batteries 38 via a charger 50. The charger 50 includes an automatic shut off for use when the batteries are being charged by an external AC connection to prevent overcharging.

In those applications where the system is to be used in a preprogrammed or automatic configuration, the equipment 14 in the trailer will include the appropriate timers and sensors 52, etc. In those applications where the system is to be remotely controlled by an operator located some distance from the trailer, the equipment in the trailer will include the appropriate transmitters and receivers as required to enable remote operation.

According to one embodiment of the invention, the trailer 2 is equipped with a solar power array 54, mounted either to the trailer or on the mast, and used to charge the batteries 38 in the trailer 2.

According to one embodiment of the invention, the equipment in the trailer is selected according to the needs of a particular application. In another embodiment of the invention, the equipment in the trailer includes a variety of commonly used equipment to accommodate a majority of requirements that might present themselves. For example, the trailer is configured to be capable of operating in a preprogrammed automatic mode, as well as a remote controlled mode, and may included a plurality of transmission means for two-way communication between the trailer and a remote location, including a connection for a phone line, a cellular link, a two-way-radio transceiver, etc. The system will also include sensors and timers as may be required for automatic operation. The system further includes batteries for providing power, as well as hook-ups for direct connection to an AC power source. This embodiment of the invention offers the operator a maximum number of configuration options without the need to modify the contents of the trailer. Such a system may be useful, for example, in a case where the exact requirements of an application are not known beforehand, or in a case where the system belongs to one party but is operated by another party, as in the case of a rental unit.

According to the principles of the invention, there are several possible configurations of camera arrangements. For example, one configuration may require the presence of a plurality of color cameras capable of independent pan, tilt, and zoom. This may be useful, for example, in monitoring the traffic at an intersection, or at a train crossing.

In another configuration, normal daylight cameras are paired with infrared cameras, providing the capability of monitoring an area under any light condition. Data from only the infrared camera may be used in some situations, or advantageously, both the daylight cameras and infrared cameras collect data and it is displayed on a split screen side-by-side of the same time, as shown in FIG. 7. The operator can thus obtain standard visual data simultaneously with obtaining and viewing infrared data to form a complete image of the observed area and things therein. Details not clear from either image alone can be more completely observed and understood when the two images are displayed and observed side-by-side on the same screen. Such an arrangement might be useful at unlit intersections, or for security surveillance.

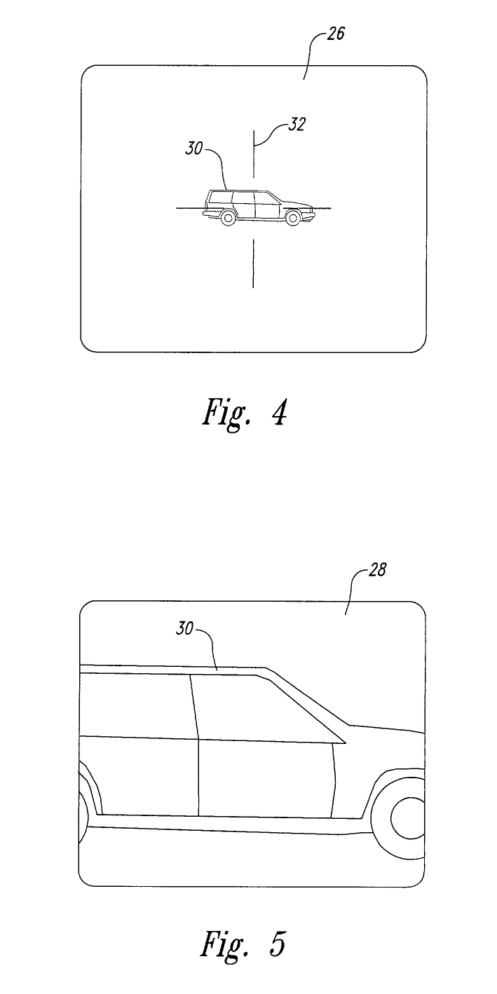

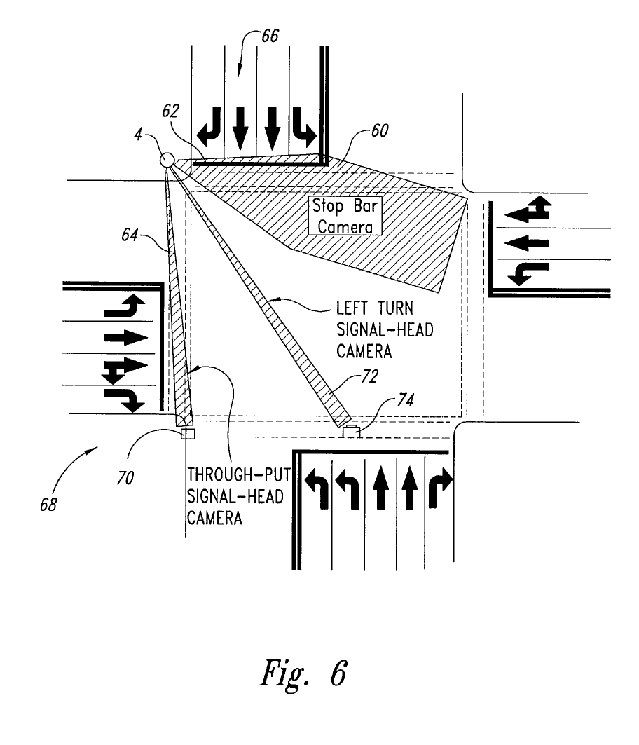

In one configuration, as illustrated in FIGS. 4 and 5, a wide-angle camera is ganged with a zoom camera or long telephoto lens camera. In such an arrangement, the cameras may be linked either mechanically or electronically in such a fashion that they pan and tilt in tandem. The video image 26 supplied by the wide-angle camera is provided with a fiducial or a cross hair 32 in the center of the image. The image 28 of the zoom camera is established such that a feature or object 30 shown in the image 28 from the zoom camera appears at the center of the cross hair 32 in the image 26 from the wide-angle camera. FIG. 4 illustrates the image 26 as viewed by a wide-angle camera with an object 30 in the center of the image, appearing between the cross hairs 32. FIG. 5 shows the view 28 from the zoom camera, showing an enlarged view of the object 30 that appears in the cross hairs 32 at the center of the image 26 of FIG. 4. Because the cameras are linked together, they move together in response to commands by a remote operator, and the image 28 from the zoom camera of FIG. 5 always remains in the center of the cross hairs 32 of the image 26 from the wide-angle camera of FIG. 4.

As an alternative to the linked cameras moving in concert, the wide angle camera may be stationary and the zoom camera movable, with the cameras linked such that the cross hairs on the screen image from the wide angle camera move in concert with the movements of the zoom camera. In this way, the operator can, by manipulating the position controls of the zoom camera, place the cross hairs on a subject of interest, and view a close-up view of that subject in the image from the zoom camera.

Such a configuration is useful in situations where an operator may find it necessary to examine details of an image. For example, an operator may wish to read the license plate number of a vehicle parked in a parking lot with many other vehicles. If the operator has only a narrow view, or a highly magnified view available to him, it may take some time to locate the particular car he is looking for and then find that license plate. On the other hand, if he has a single zoom camera available, he may spend time on a wide angle view of the parking lot and then narrowing down to a close view of the vehicle and then of the license plate to a degree where he can read the number off the plate. Meanwhile, the operator loses the wider view, and so may miss events occurring elsewhere while investigating details. In contrast, by using the configuration described above, the operator can locate a car or other feature of interest using a regular-lense or a wide-angle camera, and by centering the vehicle between the fiducials 32, on the standard or wide-angle camera the narrow view camera is, because it is slaved to the wide-angle camera, automatically aimed directly at the position desired, making it possible to quickly locate the information required, without compromising the broader image.

Another possible application of this feature is in crowd monitoring. An operator can observe a large group of people using standard or wide angle camera, and aim the standard lense camera at subjects of interest. By centering the fiducials 32 on an individual in a crowd, a magnified view of that individual is automatically captured by the longer lense camera. Since the images of both cameras are recorded, the operator need not be concerned with examining the narrow view image immediately, but may wish only to archive the information for later reference.

Crowd monitoring applications include large sports events, concerts, political rallies, festivals etc. At events such as these, it is not uncommon for acts of unlawful behavior or violence to occur, in which case video evidence becomes valuable in apprehending and prosecuting individuals involved. Having the wide angle and zoom images recorded on the same image, as split screen images, gives the advantage that, while the zoom image may be required to identify an individual, events of concern may occur outside the view of the zoom camera but within the view of the wide angle camera. By using simultaneous recording on the single image, the positional and temporal relationship between the individual captured by the zoom camera and the event captured by the wide-angle camera can be established for evidentiary purposes.

FIG. 7, which will be discussed below with reference to traffic studies, shows a single frame of such a single image, in which a car is visible, crossing the stop bar of an intersection, while simultaneously showing the traffic lights controlling the through and left turn traffic (both of which are obviously red). This image provides very strong evidence of the illegal crossing of that vehicle. A similar image, showing a close-up view of an individual, sufficient to allow positive identification, while in a split image of the same frame showing the events occurring around that individual, and the individuals participation, would provide very powerful evidence for the purposes of apprehending and prosecuting the individual, in the event of criminal or violent behavior.

In some applications, multiple trailers may be employed to capture images from various angles. In these cases, images from one trailer may be transmitted to a second one, where they may be combined with the images from the second trailer onto a single image. Again, this affords clear evidence of the time relationship between the images of the various cameras. As will be obvious to one skilled in the art, there is a wide range of options that may be employed. These include recording the images of the various cameras and trailers separately and also on a single image, which permits the advantage of the split screen image as well as the additional resolution available where an image from only one camera is recorded. Images may be recorded in each of the trailers or transmitted to a central location to be recorded there. Other combinations are also envisioned and considered to be within the scope of the invention.

The same principle—of slaving cameras together—may be applied when aiming a directional antenna at a remote antenna for the purposes of establishing radio or laser communication. For example, in one configuration, the trailer may be linked via two-way radio to a remote antenna within line of sight. In a preferred embodiment, a directional antenna is mounted to the mast, to exploit the added height available. A camera is aligned with the directional antenna and configured in such a way that when the antenna is moved the camera moves in concert. The operator can then observe through a monitor, as he adjusts the position of the antenna. Fiducials on the screen of the monitor indicate the focal point of the antenna. A strobe light, or some other visual indicator is located at the site of the remote antenna. The operator views the image from the camera on the monitor and adjusts the position of the antenna by bringing the strobe light or visual locator into the center of the fiducial, and thus may quickly and accurate align the antenna with a remote antenna. By the same token, a strobe light may be employed on the cabinet or mast of the trailer, and used as a visual locator for the alignment of a remote directional antenna located within line of sight of the trailer, to quickly establish a radio link with the trailer.

In another configuration of the system, two cameras may be aligned for stereo observation. According to a preferred embodiment of the invention, the stereo cameras are mounted on a crossbar on the mast, and spaced as far apart as possible. In such a configuration, the images may be linked to a microprocessor programmed to analyze the images. Alternatively, an operator may wear a device on his head that places a video screen in front of each of his eyes. Such a device would provide the operator with a stereo image of the field of view of the cameras. In such an application, the crossbar may include a motor to rotate the crossbar on the axis of the mast. This allows the operator to pan the cameras together and maintain the crossbar perpendicular to the subject in view.

A two camera configuration may be useful for object recognition, range finding, relative position analysis, speed and vector analysis, etc. The use of two cameras configured in a side-by-side arrangement can provide object positions to a high degree of accuracy. If the cameras are stationary and aimed at known angles relative to each other, an object moving across the image of each will appear at particular points of the screen, depending upon its position relative to the two cameras. analysis of the video information can yield the exact position of the object in three dimensions relative to the cameras, and its speed and direction of travel.

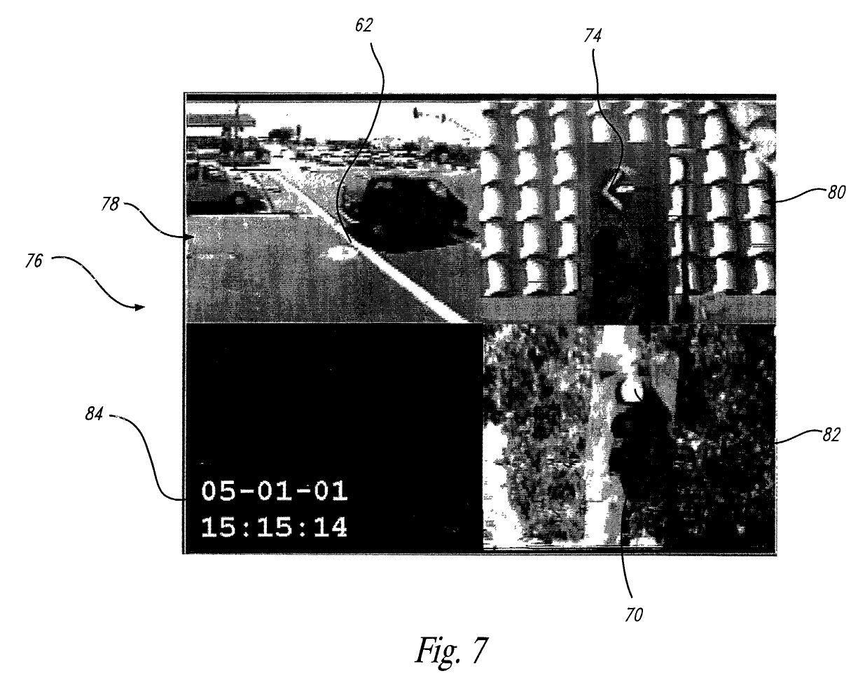

A typical application of the system as used for traffic analysis is illustrated in FIG. 6. In this configuration, three cameras are mounted to the mast 4. The cameras are arranged to record a single approach 66 to an intersection 68, together with the traffic signals that govern that approach. In such an application, one wide-angle camera is positioned with a field of view 60 to cover that single approach and the stop bar 62 (the wide, white line across the road) at the intersection. A second telephoto or zoom lens camera is positioned with a field of view 64 focused on the light signal 70 that controls the through traffic from that approach. A third camera may be positioned with a field of view 72 focused on the left-hand turn signal 74, if such a signal exists, that controls the left-hand turn lane of that approach. The images of these three cameras are routed through a screen splitting device, which records the three images from those cameras on a single frame of the recording device. Generally a time and date stamp is also applied to those frames.

FIG. 7 shows the video image 76 recorded for such a configuration. The image 78 in the upper left quadrant of the screen shows traffic crossing the stop bar 62, the image 80 in the upper right quadrant shows the left-hand turn signal 74, the image 82 in the lower right quadrant shows the through traffic signal, and the time/date stamp 84, which indicates the moment this particular frame was recorded, is in the lower left quadrant of the video image. An individual viewing this image is able to see time synchronous images of the signals, and the traffic passing those signals. In this way, photographic evidence of compliance to the traffic signals may be gathered.

When employed according to this embodiment, the recorded images are analyzed to extract the data required for the particular application. A software program is provided to permit an operator to view the video images and record the data.

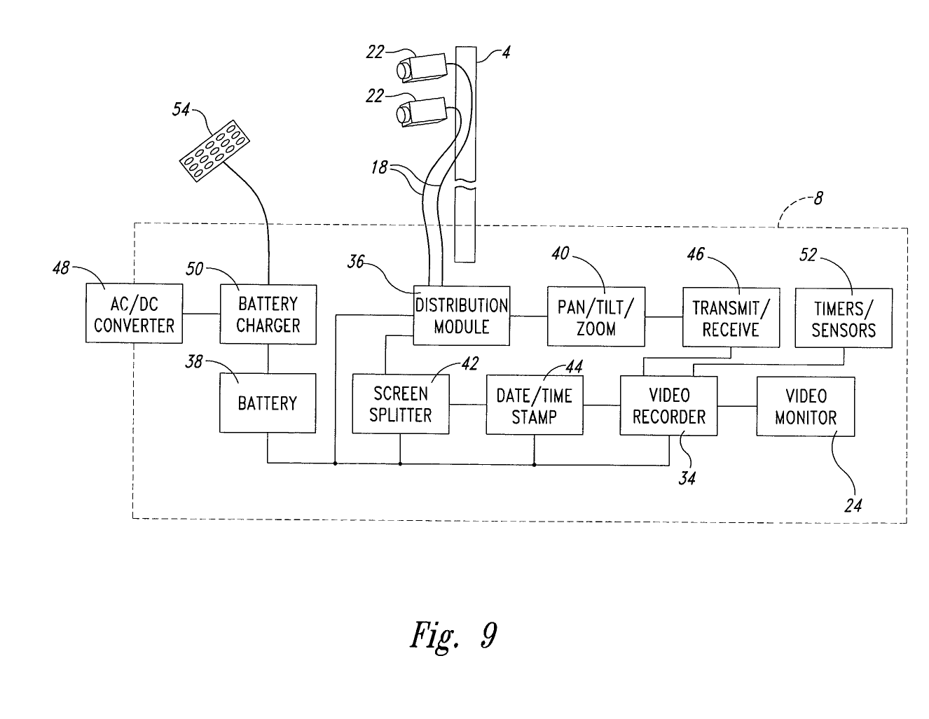

FIG. 8 shows a view of a computer screen 86, on which the video image 76 is framed by the data fields of the software program. The configuration, as shown in FIG. 8, is the same as that shown in FIGS. 6 and 7, namely, one wide angle camera showing a stop bar 62, a zoom camera focused on a left turn signal 74, and a zoom camera focused on a through traffic signal 70. The program provides fields for pertinent data, including a tape designation number 88, the location of the intersection in question 90, the times of each signal change 92, the number of cars passing the stop bar during each green light, yellow light and red light 94, the name of the operator 96 etc. The program may be modified to accommodate a wide variety of requirements and data sets, including four way approaches to an intersection, traffic distribution studies, infraction studies, congestion analysis, etc.

According to the principles of the invention, one embodiment of the system is designed for short-term use, and may be set up and operated by one person.

Common applications of these systems include traffic compliance studies, railroad grade crossings, traffic pattern studies, throughput studies, origin and destination studies, cordon studies, time vs. traffic studies, etc. The system may also be employed to observe non-vehicular traffic, including pedestrians, bicycles and skateboards. Other applications include video surveillance of public gatherings, animal control studies, surveillance and security at construction sites, and security at sporting events.

An advantage of employing mobile devices such as that described herein is that limited resources may be stretched to accommodate a greater need. For example, surveillance video equipment may be quickly and easily moved from one location to another, as the needs change. In contrast, mounting cameras at each location that will, at some time, need to be observed can be very expensive.

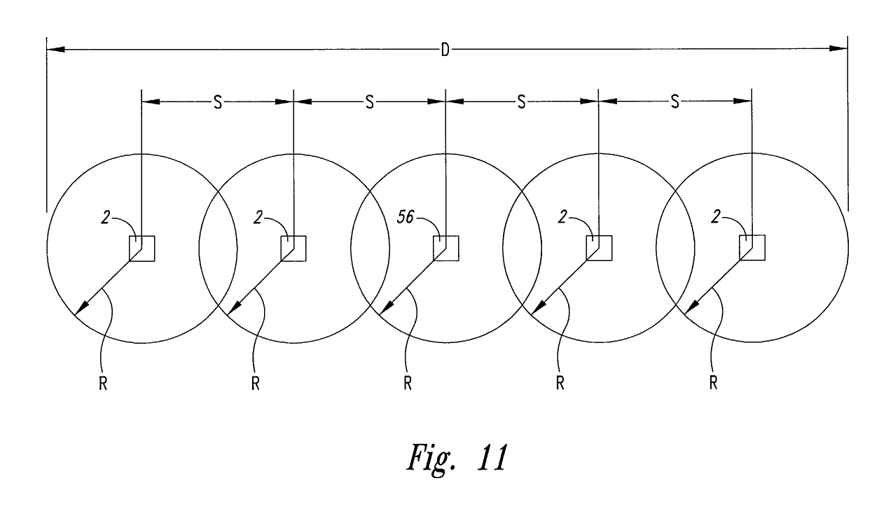

A further embodiment of the invention is described, with reference to FIGS. 10-12. According to principles of the invention, a command vehicle 56 is provided, together with a plurality of trailers 2 as previously described. The command vehicle 56 includes a mast 58 functionally identical to the masts 4 of the trailers 2. Each mast 4, 58 is configured to support a plurality of cameras 22, as described with reference to FIG. 1. Images from the pluralities of cameras of the plurality of trailers 2 are transmitted, by one of the methods previously described, to the command vehicle 56, where they are recorded, together with the images from the cameras 22 on the mast 58.

As illustrated diagrammatically in FIG. 12, the command vehicle 56 is equipped to support one or more operators for extended periods of time, and includes such equipment and amenities as will be required for a particular application. A command center 57 is provided in the command vehicle. For example, the command center 57 may contain, as indicated in block 59, video recorders and monitors to review and analyze the images from the cameras on the mast 58 and the cameras on the trailers 2. Pan/tilt/zoom controls as required are also included. Appropriate transmit and receive equipment is also included to communicate with each of the plurality of trailers. A power generator 61 for continuous electrical power is provided, together with a backup battery in case of power failure. Within the command vehicle amenities such as bunks 63, food storage 65 and preparation equipment 67, air conditioning and heating 69, water storage and sanitation 71 are provided as appropriate, based on the specific application. The command vehicle 56 may tow two or more trailers 2.

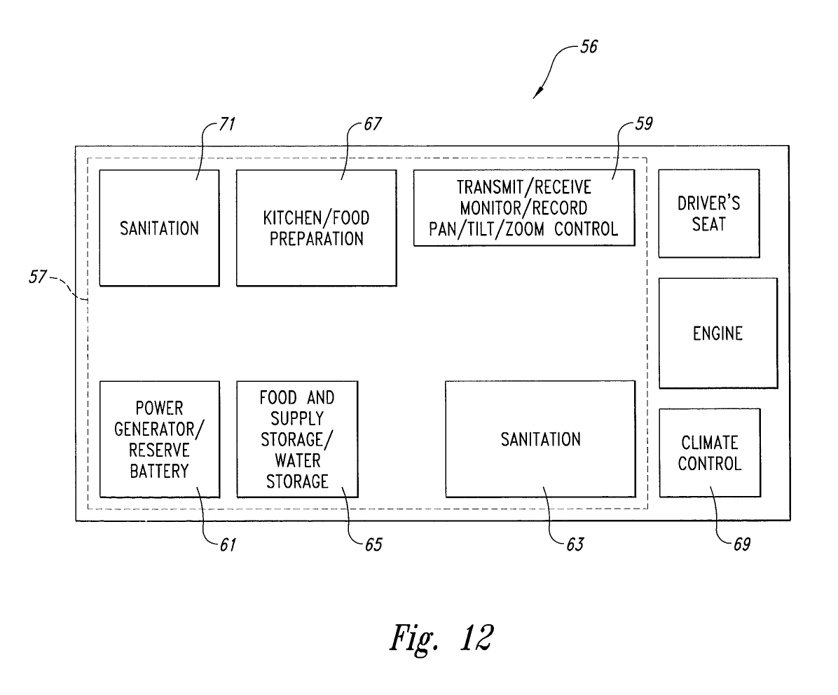

FIG. 11 illustrates one application of the embodiment described with reference to FIGS. 10 and 12. In the example illustrated, four trailers 2 are employed, positioned two each on either side of the command vehicle at a spacing S apart. This configuration may be used, for example, in border patrol and interdiction. One or two operators can quickly position the trailers and command vehicles at a site along a border, and create a patrol barrier equal to the distance D. Inasmuch as the spacing between the trailers and the command vehicle will vary, depending upon the terrain to be observed, the distance D will also vary according to the exigencies of the situation. On a flat plain, the distance to the horizon from a camera thirty-five feet above the ground will be nearly eight miles, so the effective radius R of visibility of a camera will be largely limited by its power and resolution. So, for example, if the effective radius R of the cameras illustrated in FIG. 11 is two miles, and the cameras are placed at a spacing S of three miles, the distance D under observation will be sixteen miles. An individual in the command vehicle can immediately detect movement within the range of observation, and call in ground or air support to interdict an incursion. If the exact position of each of the trailers 2 is known, with reference to the command vehicle 56, the position of individuals or features in sight of the cameras 22 of the trailers or command vehicle 56 can be known to a high degree of confidence. Such a system can be in place in hours, and stay briefly or for periods of days or more. It can be moved to new locations easily and without advance notice.

The equipment in the command vehicle 56 may include a microprocessor capable of detecting movement in the field of view of the cameras. An alarm would notify the operator of the movement, who could then, utilizing the dual camera configuration described above with reference to FIGS. 4 and 5, quickly determine the source and location of the movement and respond appropriately. The system may include infrared cameras for nighttime surveillance. This system would be useful in various kinds of surveillance, such as along national borders or property lines or for crime control in large-scale public gatherings as previously described. Obviously, the trailers would be positioned as required for a particular application.

While specific examples have been given to illustrate novel features of the invention, the examples given are not intended to represent a complete list of the possible applications or variations that fall within the scope of the invention. Many other applications will become apparent to those skilled in the art, and are considered to be within the scope of the invention.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A video surveillance system, comprising:
a wheeled trailer;
a lockable cabinet mounted on the trailer;
a mast, coupled to the trailer and capable of being folded for storage and transport and capable of being extended vertically;
a plurality of video cameras mounted on the mast;
a screen splitter located within the cabinet and configured to receive a plurality of video images at each of a plurality of inputs and to combine the plurality of images into a single video image at an output;
a video recorder located within the cabinet and having an input coupled to the output of the screen splitting device; and
connection means for coupling outputs of each of the plurality of video cameras to a respective one of the plurality of inputs of the screen splitting device.

2. The video surveillance system of claim 1, further comprising means for providing power to the plurality of video cameras, the screen splitter, and the video recorder.

3. The video surveillance system of claim 2 wherein the means for providing power comprises a battery, and wherein the battery is located within the cabinet.

4. The video surveillance system of claim 1, further comprising timing means for activating the video recorder and the plurality of cameras at desired timing intervals.

5. The video surveillance system of claim 1, further comprising means for pan, tilt and zoom control of the plurality of cameras.

6. A remote video surveillance system, comprising:
a wheeled trailer;
a lockable cabinet mounted on the trailer;
a mast, coupled to the trailer and capable of being folded for storage and transport and capable of being extended vertically;
a plurality of video cameras mounted on the mast;
transmission means for transmitting images from each of the plurality of video cameras to a remote location; and
connection means for coupling outputs of each of the plurality of video cameras to the transmission means.

7. The remote video surveillance system of claim 6, further comprising:
means for controlling pan, tilt and zoom of each of the plurality of video cameras; and
reception means for receiving remote control signals for operating the control means.

8. The remote video surveillance system of claim 7 wherein:
a first one of the plurality of video cameras includes a wide angle lens;
a second one of the plurality of video cameras includes a lens that is much narrower than the lens of the first video camera;
the field of view of the second video camera is indicated by a fiducial in the video image from the first camera.

9. The remote video surveillance system of claim 8 wherein the fiducial is chosen from a list that includes cross hairs, corner marks and a rectangular box.

10. The remote video surveillance system of claim 8 wherein the second camera is slaved to the first camera, such that movement of the first camera is repeated by the second camera, and such that the fiducial indicating the field of view of the second camera remains in the center of the video image from the first camera.

11. The remote video surveillance system of claim 8 wherein the second camera is controllable independently of movement of the first camera, and wherein the position of the fiducial in the video image from the first camera moves within the image in concert with movements of the second camera.

12. The remote video surveillance system of claim 6, further comprising recording means in the cabinet for recording the images from the video cameras.

13. The remote video surveillance system of claim 6 wherein the wheeled trailer is one of a plurality of wheeled trailers, each comprising:
a lockable cabinet mounted on the trailer;
a mast, coupled to the trailer and capable of being folded for storage and transport and capable of being extended vertically;
a plurality of video cameras mounted on the mast;
transmission means for transmitting images from each of the plurality of video cameras to a remote location; and
connection means for coupling outputs of each of the plurality of video cameras to the transmission means.

14. The remote video surveillance system of claim 13 wherein the transmission means of each of the plurality of trailers transmits the video images to a common remote location.

15. The remote video surveillance system of claim 14 wherein each of the video images from each of the transmission means are recorded at the common remote location.

16. The remote video surveillance system of claim 15 wherein a plurality of the video images recorded at the common location are combined and recorded on a single video image as a split screen image.

17. The remote video surveillance system of claim 14 wherein the common remote location is a command vehicle comprising:
a mast, coupled to the command vehicle and capable of being folded for storage and transport and capable of being extended vertically;
a plurality of video cameras mounted on the mast;
reception means for receiving the transmitted images from each of the plurality of wheeled trailers;
recording means for recording the transmitted images from each of the plurality of wheeled trailers and for recording video images from each of the plurality of video cameras mounted on the mast coupled to the command vehicle;
monitoring means for viewing the images recorded by the recording means.

18. The remote video surveillance system of claim 17 wherein the command vehicle further comprises amenities for providing comfort to occupants of the command vehicle, including:
food storage and preparation facilities;
sanitation facilities;
sleeping facilities;
climate control facilities.

19. A video surveillance system, comprising:
a first video camera having a first focal length;
a second video camera coupled to the first camera and having a second focal length longer than the first focal length;
monitoring means for displaying video images from the first and second video cameras, wherein the video image from the first video camera includes a fiducial indicating the field of view of the second camera, and wherein the video image from the second camera corresponds to the portion of the video image from the first camera indicated by the fiducial.

20. The video surveillance system of claim 19 wherein the video images of the first and second cameras are displayed together in a single video image as a split screen display.

21. The video surveillance system of claim 19 wherein the second video camera is coupled to the first video camera such that the first and second cameras move in concert, and such that the video image from the second video camera corresponds to a central portion of the video image from the first camera.

22. The video surveillance system of claim 19 wherein the second video camera is coupled to the first video camera such that movements of the second camera are reflected by movements of the fiducial in the video image from the first camera.

23. A device for antenna alignment, comprising:
an antenna;
a video camera coupled to the antenna;
monitoring means for viewing a video image from the video camera, wherein the video image includes a fiducial corresponding to a focal point of the antenna.

24. The device of claim 23, further comprising a remote antenna including an indicator visible when viewed in the video image such that when the antenna is positioned to align the fiducial in the video image with the indicator in the video image, the antenna is correctly aligned with the remote antenna for communication therebetween.
